(19) United States
(12) Patent Application Publication
(10) Pub. No.: US 2008/0205669 A1
(43) Pub. Date: Aug. 28, 2008

(54) Sound Pickup Device for Acoustic String Instrument

(76) Inventor: Gerard Claude Michelet, St. Herblain (FR)

Correspondence Address: Young & Thompson, 745 S. 23rd Street., Second Floor, Arlington, VA, 22202, US

(21) Appl. No.: 11/915,893

(22) PCT Filed: May 24, 2006
(86) PCT No.: PCT/FR2006/001202

§ 371 Date: Jan. 30, 2008

(30) Foreign Application Priority Data
May 31, 2005 (FR) 05 05534

(51) Int. Cl. G10H 1/00; G10D 1/08

(52) U.S. Cl. 381/118; 84/267

(57) ABSTRACT

The invention concerns a sound pickup device for acoustic instrument (10), preferably a string instrument, in particular a plucked string instrument, such as an acoustic guitar, stroke or struck string instrument. Said device is characterized in that it comprises: at least two overhead microphones (1, 2) designed to be positioned above the instrument (10), outside the instrument (10), wherein said microphones (1, 2) are large bandwidth microphones one of which constitutes a preferably low frequency sensor, the other preferably a high frequency sensor in such a way that a wide spectrum of bass and trebles is covered; and at least another relay box (6) whereto each microphone (1, 2) is connected, said relay box (6) being adapted to transport sounds in parallel receiving, in parallel, in input, the signals of the microphones (1, 2) and being adapted to transmit, in parallel, in output, by wire our wireless connection to a mixing console or to a preamplifier.

This invention relates to an acoustic sound-pickup device for an acoustic instrument, preferably a stringed instrument, in particular a plucked stringed instrument, such as an acoustic guitar, or a bowed stringed instrument, such as a cello, or a percussion instrument, and a stringed instrument that is equipped with such a device as well as a sound-pickup method using such a device.

The sound pickup and the sound system of acoustic stringed, percussion or ethnic instruments pose numerous problems. Actually, when an electrodynamic or electrostatic microphone is placed in front of the instrument, the sound has a variable quality according to the type of microphone, and a lack of proximity and precision dynamics is noted. Such a microphone is sensitive and even very sensitive to the Larsen effect during use on stage. The sound changes when the instrumental performer moves. In addition, the sound source is unique and during a concert, the instrument is difficult to pick out from the mix. Generally, a microphone base that may be a problem to the instrumental performer and that may degrade the visual appearance is used.

Solutions that integrate a sound pickup directly on the instrument have also been imagined. Such is the case of the solution that is described in the Patent EP-A-0,238,187. The latter describes the use of a contact microphone in cooperation with cymbals. The problem of using a piezoelectric, transducer or electrodynamic type of contact microphone attached to the body of the instrument or, for example, inside a sound box in the case of an instrument that is equipped with such a box is that such microphones do not bring out the full extent of the sound range or the aerial side of the sound. Actually, such microphones pick up only the sounds that result from the vibration of the walls on which they are applied.

By virtue of the German Document DE-3,426,247, an electric guitar that consists of microphones positioned over the body of an instrument is also known. However, such microphones are electromagnetic microphones that react to the vibrations of the strings. The absence of such microphones induces the absence of sound production. In this document, the microphones are connected to the mixing box, itself connected at the output to a memory that is connected by a single output to an emitter that transmits the sound to loudspeakers. The output is the mono voice type. The box therefore does not act as a relay box but a mixing box of sounds obtained from microphones and the instrument. The acoustic version of such an instrument is considered, but the type and the number of microphones used, just like the position of the microphones on such an instrument, are not described. Such a solution therefore does not make it possible to enhance and to bring out the acoustic and aerial sound of the instrument to its full extent.

One object of this invention is therefore to propose a sound-pickup device whose design makes it possible to increase the acoustic yield of the instrument.

Another object of this invention is to propose a sound-pickup device whose design allows a quick and easy installation.

For this purpose, the invention has as its object an acoustic sound-pickup device for an acoustic instrument, preferably a stringed instrument, in particular a plucked stringed instrument, such as an acoustic guitar, or a bowed stringed instrument, or a percussion instrument, characterized in that this device comprises:
At least two aerial microphones arranged to be positioned on the instrument, on the exterior of the instrument, whereby these microphones are wideband microphones, one of which can constitute a preferably low-frequency sensor and the other of which can constitute a preferably high-frequency sensor to cover a broad range of low to high registers, and
At least one relay box to which each microphone is connected, whereby this relay box, which is able to conduct sounds in parallel, receives in parallel signals from each of the microphones at its input and is able to transmit them, in parallel, at the output, by wire or wireless connection to a mixing console or to a preamplifier.

Because of their position on the instrument, one of the microphones is used as a sensor preferably of high-pitched sounds and the other is used as a sensor preferably of low-pitched sounds. This position of the microphones, at most close to the sound source, and/or playing of the instrumental performer and the type of microphones used make it possible, by multiplying the sources of sound, to obtain a device with a maximum gain that greatly limits the Larsen effects. These characteristics also make possible a left-right spatialization of the instrument in mixing with the aid of pan shots as well as the separate processing of sounds obtained from microphones for equalization and effects. Such a device allows an instrumental performer to move without the sound changing and offers different or additional sound colors for the same instrument. It avoids the problem caused by a microphone base and improves the visual side. Such a device makes it possible, with its differentiated-frequency microphones, to cover a broad range of low to high registers.

The invention will be better understood upon reading the following description of embodiments, with reference to the accompanying drawings, in which:

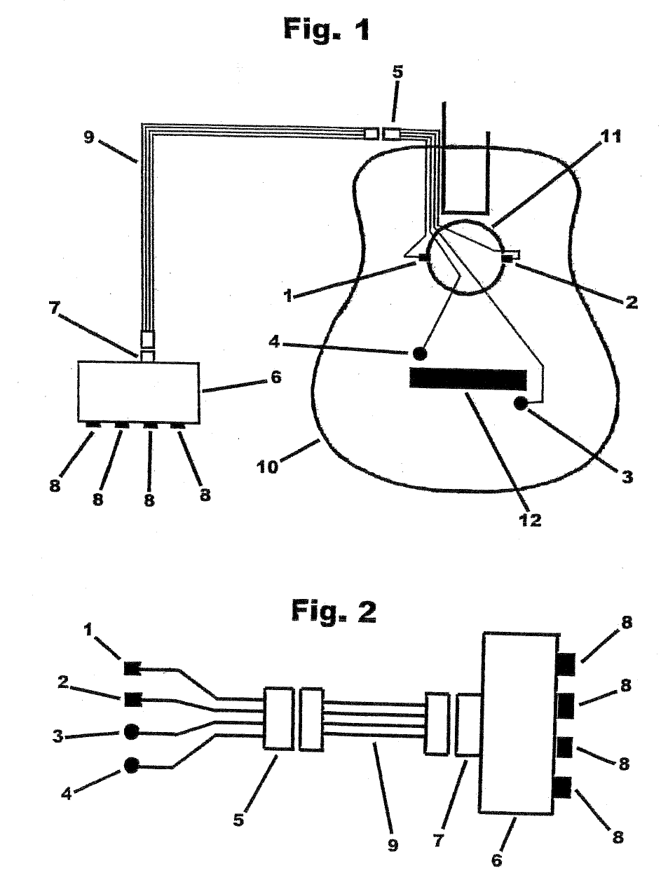

FIG. 1 shows a diagrammatic top view of an instrument, in this case a guitar, equipped with a sound-pickup device according to the invention, and

FIG. 2 shows a diagrammatic view of a sound-pickup device according to the invention.

As mentioned above, the sound-pickup device, object of the invention, comprises at least two aerial microphones 1, 2 that are designed to be positioned on the instrument 10, on the exterior of the instrument 10. Aerial microphone means any type of open microphone, picking up ambient sounds transmitted by vibrations of the air. Contact microphone means any type of microphone picking up the sounds resulting from the vibration of surfaces and in particular walls on which they are applied. These aerial microphones 1, 2, in contrast to the contact microphones, pick up the sounds that are transmitted by the vibrations of the air. These microphones 1, 2 are wideband microphones that are positioned at the level of the instrument close to the natural source of the sound and/or playing of the instrumental performer, respectively one in a low-pitch position and the other in a high-pitch position to constitute a preferably low-frequency sensor for one and a preferably high-frequency sensor for the other. These wideband aerial microphones 1, 2, preferably omnidirectional or cardioid, are of the electret type. These microphones are actually part of the family of electrostatic electret microphones. These microphones are equipped with means, such as an adhesive or a fixing paste, for attachment to the instrument 10 for the purpose of positioning them at least for one, close to a natural emission source of low-frequency sounds and for at least one other or the other microphone, close to an emission source of high-frequency sounds.

An example of positioning such microphones will be described below.

The sound-pickup device, object of the invention, can also comprise in addition at least one contact microphone 3, preferably of the piezoelectric, electrodynamic or transducer type, connected to said relay box 6. The proximity of the microphones to their source allows a pickup of sound without phase shift.

In the examples shown, below, the sound-pickup device comprises at least two contact microphones 3, 4, preferably a piezoelectric, electrodynamic or transducer type, each connected to said relay box 6, whereby said microphones 3, 4 are of identical or different type.

Each microphone 1, 2, 3, 4 is therefore connected to said relay box 6 to allow a transmission in parallel of the sounds from each of the microphones to said box, whereby this box is itself connected at the output by connections that are parallel to a mixing console or a preamplifier.

An example of connection between microphones and box is illustrated in FIG. 2. In this case, each microphone 1, 2, 3, 4 is connected by wire to a multipin connector 5 and constitutes a pre-cabled unit. The multipin connector 5 that equips said microphones is preferably a male connector. For its part, the relay box 6 is equipped at the input with a multipin connector 7 that is preferably female.

The connection between microphones and relay box 6 can therefore simply be operated by direct connection of their multipin connectors 5, 7.

In the embodiment shown, the microphones 1, 2, 3, 4 and the relay box 6 are connected to one another by a multiconductor connecting cable that is equipped at each of its ends with a multipin connector, whereby one of the connectors works with the multipin connector 5 of the microphones 1, 2, 3, 4, and the other with the one shown at 7 in the figures of the relay box 6. This arrangement thus makes possible the relaying in parallel of the sounds from each of the microphones to the relay box 6. This relay box 6 is equipped at the output with a number of independent outputs, whereby each output corresponds to the signals of a microphone, each output consists of an asymmetrical jack connector 8 and/or a symmetrical XLR TRS (tip ring slave) connector so as to direct the signals from each of the microphones to the inputs of a mixing console or a preamplifier, whereby each input corresponds to the signals that are obtained from a microphone.

The relay box 6 therefore comprises at the output as many connecting outputs as it has connecting points to the microphones on input.

This relay box 6 can settle for performing the role of transmitting signals obtained from each of the microphones to the corresponding input of a mixing console or a preamplifier.

This relay box 6 can also comprise means for symmetrization of the signal that transforms the two-point asymmetrical signal from each microphone 1, 2, 3, 4 into a three-point symmetrical signal and/or means of calibrating the volume of each microphone and/or means for equalizing signals obtained from each microphone. In this case, the box ensures—parallel to the transmission of the signals—a processing of these signals without mixing the signals obtained from a microphone with those obtained from another microphone.

In the case of the application of such a sound-pickup device to a percussion instrument, one of the electret-type wideband microphones is positioned close to the striking of the instrument to pick up the high-pitched sounds of the striking, while another electret-type microphone is positioned close to the air-hole to pick up the preferably low-pitched sounds from the air-hole that are produced by the instrument.

In the case of a plucked stringed instrument, in particular an acoustic guitar of the type that has at least one rose 11 and one bridge 12, the electret-type wideband microphones 1, 2, of the sound-pickup device are positioned on the exterior of the instrument 10 at the edge of the rose 11, one close to the lowest-pitched string and the other close to the highest-pitched string of the instrument 10, whereby these microphones 1, 2 are oriented in the direction of said strings of said instrument 10. In this case, the sound-pickup device can comprise in addition at least one contact microphone 3, 4 that is positioned close to the bridge 12. In the example shown, two contact microphones are provided. All of these microphones are connected to the relay box 6 as mentioned above.

The contact microphones that are not sensitive to the Larsen effect make it possible to bring out the playing of the instrumental performer, the media, the attack and the box sound of the instrument. For their part, the aerial wideband microphones 1 and 2 make possible an actual low-register and high-register stereo sound pickup having a very good proximity dynamic, a broad sound, full and aerial and a very good precision.

In the embodiment that is shown in FIG. 1, the relay box 6 is located at some distance from the instrument. However, the latter can, in an equivalent manner, be attached either to the exterior of the instrument or, in a permanent manner, to the interior of the box of the instrument. Here, the cables of each microphone run along the sleeve of said instrument and end by the multipin connector 5. The signals are then transmitted to the relay box 6 by a multiconductor cable 9 that is connected to the relay box 6 via the multipin connector 7. The connection between the relay box 6 and the mixing console or preamplifier can be made by a wire or wireless connection. In this case, for example, a high-frequency system with a four-band emitter-receiver is provided between the relay box 6 and the mixing console.

The microphones that are used can, in the case of electret-type microphones, be active microphones that cover a frequency range of 20 Hertz to 20,000 Hertz and require a power supply. The contact microphones can frame piezoelectric or electrodynamic microphones that cover a range of 100 Hertz to 8,000 Hertz and are of the passive type.

As has been mentioned above, the relay box 6 houses an electric power supply of wide-band microphones 1, 2, whereby this electric power supply can consist of a cell or a 48-volt phantom power supply.

As mentioned above, the installation of such a sound-pickup device on a musical instrument can be performed extremely easily owing to the presence of fixing paste or adhesive or a self-gripping connection at the microphones 1, 2, 3, 4, of the sound-pickup device. The latter can be positioned at the level of the instrument on the outside body of the latter or inside the resonance box or in the bridge for the contact microphones 3, 4 when this is necessary. The pre-cabling of the microphones and the facility of their connection with the relay box 6 also makes it possible to perform the connection between the various elements of the device in a very short time. Consequently, such a sound-pickup device can be detached after each use of the instrument or be kept permanently on said instrument and/or can be factory-installed on said instrument without exceeding the scope of the invention.

It should be noted that the term micro above constitutes the abbreviation of the term microphone each time and constitutes the equivalent thereof.

1. Sound-pickup device for an acoustic instrument (10), preferably a stringed instrument, in particular a plucked stringed instrument, such as an acoustic guitar, or a bowed stringed instrument, such as a cello, or a percussion instrument,
characterized in that this device comprises:
At least two aerial microphones (1, 2) arranged to be positioned on the instrument (10), on the exterior of the instrument (10), whereby these microphones (1, 2) are wideband microphones, one of which can constitute a preferably low-frequency sensor and the other of which can constitute a preferably high-frequency sensor to cover a broad range of low to high registers, and
At least one relay box (6) to which each microphone (1, 2) is connected, whereby this relay box (6), which is able to conduct sounds in parallel, receives in parallel signals from each of the microphones (1, 2) at its input and is able to transmit them, in parallel, at the output, by wire or wireless connection to a mixing console or to a preamplifier.

2. Device according to claim 1, wherein the wideband aerial microphones (1, 2), preferably omnidirectional or cardioid, are of the electret type and are equipped with means, such as an adhesive or a fixing paste, for attachment to the instrument (10) for the purpose of positioning them at least for one, close to a natural emission source of low-frequency sounds and for at least one other or the other microphone, close to an emission source of high-frequency sounds.

3. Device according to claim 1, wherein it also comprises at least one contact microphone (3), preferably of piezoelectric, electrodynamic or transducer type, connected to said relay box (6).

4. Device according to claim 3, wherein it comprises at least two contact microphones (3, 4), preferably of piezoelectric, electrodynamic or transducer type, each connected to said relay box (6), whereby said microphones (3, 4) are of identical or different type.

5. Device according to claim 1, wherein each microphone (1, 2, 3, 4) is connected by wire to a multipin connector (5), preferably male, to form a pre-cabled unit, and wherein the relay box (6) is equipped at the input with a multipin connector (7), preferably female.

6. Device according to claim 5, wherein the microphones (1, 2, 3, 4) and relay box (6) are connected to one another by direct connection of their multipin connectors (5, 7).

7. Device according to claim 5, wherein the microphones (1, 2, 3, 4) and the relay box (6) are connected to one another by a multiconductor connecting cable that is equipped at each of its ends with a multipin connector, whereby one of the connectors works with the multipin connector (5) of the microphones (1, 2, 3, 4), and the other works with that (7) of the relay box (6).

8. Device according to claim 1, wherein the relay box (6) is equipped with a number of independent outputs, whereby each output corresponds to the signals of a microphone (1, 2, 3, 4), whereby each output consists of an asymmetrical jack connector (8) and/or a symmetrical XLR TRS (tip ring slave) connector.

9. Device according to claim 1, wherein the relay box (6) houses an electric supply of the wideband microphones (1, 2).

10. Device according to claim 1, wherein the relay box (6) comprises means for symmetrization of the signal that transforms the two-point asymmetrical signal from each microphone (1, 2, 3, 4) into a three-point symmetrical signal and/or means for calibrating the volume of each microphone and/or means for equalizing signals that are obtained from each microphone.

11. Plucked stringed instrument, in particular an acoustic guitar of the type that has at least one rose (11) and one bridge (12), wherein the instrument is equipped with a sound-pickup device according to claim 1, whereby the electret-type wideband microphones (1, 2) of the sound-pickup device are positioned on the exterior of the instrument (10) at the edge of the rose (11), one close to the lowest-pitched string and the other close to the highest-pitched string of the instrument (10), whereby these microphones (1, 2) are oriented in the direction of said strings of said instrument (10).

12. Plucked stringed instrument according to claim 11, wherein the sound-pickup device also comprises at least one contact microphone (3, 4) that is positioned close to the bridge (12).

13. Acoustic sound-pickup method for an acoustic instrument (10), preferably an acoustic stringed instrument, in particular a plucked stringed instrument, such as an acoustic guitar, or a bowed stringed instrument, such as a cello, or a percussion instrument,
wherein it comprises at least one stage for positioning—on the exterior of the instrument, close to the source of the sound and/or the playing of the instrumental performer, in respectively low-pitch and high-pitch position, close to openings, such as sound-holes, rose (11) or striking and the air-hole of the instrument or the bowing of the strings and a sound-hole—at least two wideband aerial microphones (1, 2), one constituting a preferably low-frequency sensor and the other a preferably high-frequency sensor to cover a broad range of low to high registers, and a stage for connecting said microphones (1, 2) to a relay box (6), whereby this relay box (6), which is able to conduct sounds in parallel, receives in parallel signals from each of the microphones at its input and is able to transmit them in parallel, at the output, by a wire or wireless connection, to a mixing console or a preamplifier.

14. Device according to claim 2, wherein it also comprises at least one contact microphone (3), preferably of piezoelectric, electrodynamic or transducer type, connected to said relay box (6).

15. Device according to claim 2, wherein each microphone (1, 2, 3, 4) is connected by wire to a multipin connector (5), preferably male, to form a pre-cabled unit, and wherein the relay box (6) is equipped at the input with a multipin connector (7), preferably female.

16. Device according to claim 3, wherein each microphone (1, 2, 3, 4) is connected by wire to a multipin connector (5), preferably male, to form a pre-cabled unit, and wherein the relay box (6) is equipped at the input with a multipin connector (7), preferably female.

17. Device according to claim 4, wherein each microphone (1, 2, 3, 4) is connected by wire to a multipin connector (5), preferably male, to form a pre-cabled unit, and wherein the relay box (6) is equipped at the input with a multipin connector (7), preferably female.

18. Device according to claim 2, wherein the relay box (6) is equipped with a number of independent outputs, whereby each output corresponds to the signals of a microphone (1, 2, 3, 4), whereby each output consists of an asymmetrical jack connector (8) and/or a symmetrical XLR TRS (tip ring slave) connector.

19. Device according to claim 3, wherein the relay box (6) is equipped with a number of independent outputs, whereby each output corresponds to the signals of a microphone (1, 2, 3, 4), whereby each output consists of an asymmetrical jack connector (8) and/or a symmetrical XLR TRS (tip ring slave) connector.

20. Device according to claim 4, wherein the relay box (6) is equipped with a number of independent outputs, whereby each output corresponds to the signals of a microphone (1, 2, 3, 4), whereby each output consists of an asymmetrical jack connector (8) and/or a symmetrical XLR TRS (tip ring slave) connector.
